(19) United States
(12) Patent Application Publication
(10) Pub. No.: US 2011/0004838 A1
(43) Pub. Date: Jan. 6, 2011

(54) INTERFACE APPARATUS AND METHOD FOR MANAGING ELEMENTS HAVING ELASTICITY

(76) Inventor: Won Kyu Lee, Goyang-si (KR)

Correspondence Address: North Star Intellectual Property Law, PC, P.O. Box 34688, Washington, DC, 20043, US

(21) Appl. No.: 12/648,515

(22) Filed: Dec. 29, 2009

(30) Foreign Application Priority Data
Jul. 1, 2009 (KR) 10-2009-0059843

(51) Int. Cl. G06F 3/048

(52) U.S. Cl. 715/765

(57) ABSTRACT

An interface apparatus and method of an element having a changeable length are provided. The interface apparatus includes a display unit to display an element having an elasticity which is adjustable, and a reference axis for arranging the element. The interface apparatus includes an interface unit to sense a manipulation with respect to the element, and a control unit to change a display state of the element based on the sensed manipulation. The control unit inserts, removes, divides, combines, and/or groups elements based on the manipulation with respect to the element, and adjusts the element using an adjustment tab.

### CROSS-REFERENCE TO RELATED APPLICATION

This application claims the benefit under 35 U.S.C. §119(a) of a Korean Patent Application No. 10-2009-0059843, filed on Jul. 1, 2009, in the Korean Intellectual Property Office, the entire disclosure of which is incorporated herein by reference for all purposes.

### BACKGROUND

1. Field

The following description relates to an interface apparatus and method for managing elastic elements, and more particularly, to an interface apparatus and method for intuitively arranging and displaying elements having an elasticity, and adjusting, adding, and/or removing the elements in a display.

2. Description of Related Art

Current electronic devices may provide various functions for a user convenience as well as their inherent functions, and a schedule management function may be one of them.

In particular, a mobile communication terminal may provide a schedule management function that may manage individual information of the user of the mobile terminal. This schedule management function may be a function that may announce, to a user at a corresponding date or time, a schedules event designated in advance which a user wishes to remember.

When registering a new task in a schedule, the user may need to open a schedule management menu, and input task information in an input window. A user may input information about an event that they wish to schedule and/or be reminded of. For example, a user may desire to schedule a reminder of a seminar, and the user may input task information of the seminar, for example, ∘ month, ∘ date, and ∘ time to ∘ month, ∘ date, and ∘ time”, a start date, a start time, an end date, and an end time may be inputted and “seminar” may be inputted in a character input field. In this manner, when a new schedule is stored, contents of the schedule may be displayed at the time of retrieving the new schedule. Also, a notification function may be set to correspond to the new schedule, and an alarm may go off at a desired time to remind the user of the event.

Accordingly, to add a new task in an existing schedule management, the schedule management menu has to be opened, and all corresponding task information, that is, a date, a time, and task contents, are must be inputted.

In the above described schedule management method, events may be added that coincide with a previously added event. Thus, it may be difficult for a user of the mobile terminal to recognize a conflict in scheduling. That is, it may be difficult for a user to know that they have scheduled an event at a time that overlaps with an event they have previously scheduled. Also, a user may desire to modify an amount of time allocated to a scheduled event based upon whether the event is fixed, or whether the event is flexible.

### SUMMARY

In one aspect, there is provided an interface apparatus, comprising a display unit to display an element having an elasticity and a length which are adjustable, and a reference axis for arranging the element, an interface unit to sense a manipulation with respect to the element, and a control unit to change a display state of the element based on the sensed manipulation.

The element may be generated based on elasticity information indicating elasticity, initial length information, and the amount the length may be adjusted.

The manipulation with respect to the element may be performed by an adjustment tab for fixing and adjusting the element, and the interface unit senses a movement of the adjustment tab.

The element may be compressed or moved in correspondence with the manipulation of the adjustment tab.

The manipulation with respect to the element may include inserting the element into a selection area of the reference axis, and the control unit inserts the element into the selection area without changing the length of the element, when the selection area has a sufficient space where the element is inserted.

The manipulation with respect to the element may include inserting the element into a selection area of the reference axis having elements already arranged therein, and before the element is inserted the control unit performs at least one of moving the elements already arranged therein, compressing the elements already arranged therein, and compressing the element to create sufficient space for the element to be inserted.

The manipulation with respect to the element may include attempting to insert the element into a selection area of the reference axis having elements already arranged therein, and the control unit moves and adjusts a length of elements already arranged in the reference axis and a length of the element to be inserted to thereby insert the element into the selection area, and determines that the selection area does not have sufficient space for the element even though the elements already arranged in the reference axis are moved and the element and the elements already arranged are compressed.

The interface unit may sense a movement of the element outside of a display area, and the control unit may remove the element from the display area.

The manipulation with respect to the element may be performed by a division tab for dividing the element, the interface unit may sense a manipulation of the division tab, and the control unit may divide the element into two elements each having the same elasticity.

The interface unit may sense a manipulation of a combination tab for combining elements already arranged in the reference axis, and the control unit may combine the elements having been arranged in the reference axis into a single element to correspond to the combination tab.

The manipulation with respect to the element may include grouping elements already arranged in the reference axis, the interface unit may sense a selection of elements to be grouped, and the control unit may group the selected adjacent elements into a single element maintaining an elasticity of each of the selected elements.

The element may be a task being applicable in a scheduler, and the reference axis is a time axis being applicable in the scheduler.

The task may include task information, and the task information may include at least one of a task name, a fixed start time, a fixed end time, a duration time, and a flexible time.

The duration time may be displayed in a shape of a rectangle, and the flexible time may be displayed in a shape of a spring.

The scheduler may be divided into a past region and a future region based on a current time, and the divided scheduler may be displayed.

The past region and the future region may be divided by shading or watermarks.

The scheduler may display a current time designation tab indicating a current time in the time axis.

In another aspect, there is provided an interface method, comprising displaying an element having an elasticity and a length which is adjustable and a reference axis for arranging the element, sensing a manipulation with respect to the element, and changing a display state of the element based on the sensed manipulation.

The element may be compressed or moved by an adjustment tab for fixing or adjusting the element.

The changing may insert the element into a selection area of the reference axis without changing the length of the element when the selection area has a sufficient space where the element is to be inserted.

The changing may change the length of the element to insert the element into a selection area of the reference axis.

The changing may change a length of elements already arranged in the reference axis based on an elasticity of the elements already arranged to thereby insert the element into a selection area of the reference axis.

The changing may remove or divide the element based on the sensed manipulation.

The changing may group or combine elements having been arranged in the reference axis based on the sensed manipulation, and a length of the elements having been arranged is changeable based on an elasticity.

Other features and aspects will be apparent from the following detailed description, the drawings, and the claims.

### BRIEF DESCRIPTION OF THE DRAWINGS

FIG. 1 is a diagram illustrating an example of an interface apparatus.

FIG. 2A is a diagram illustrating an example of an element having an elasticity.

FIG. 2B is a diagram illustrating an example in which an element having an elasticity is adjusted depending on a change in the elasticity.

FIG. 3 is a diagram illustrating an example of a display.

FIG. 4 is a diagram illustrating an example of generating an element having an elasticity.

FIG. 5 is a diagram illustrating an example of adjusting elements having an elasticity using an adjustment tab.

FIG. 6 is a diagram illustrating another example of adjusting elements having an elasticity using an adjustment tab.

FIG. 7 is a diagram illustrating an example of moving an element.

FIG. 8 is a diagram illustrating another example of moving an element.

FIG. 9 is a diagram illustrating an example of a failure to move an element.

FIG. 10 is a diagram illustrating an example of removing an element.

FIG. 11 is a diagram illustrating an example of grouping elements to generate an element group.

FIG. 12 is a diagram illustrating an example of dividing an element.

FIG. 13 is a diagram illustrating an example of combining elements.

FIG. 14 is a diagram illustrating an example of changing the elasticity of an element.

FIG. 15 is a diagram illustrating an example of outputting additional information where an adjustment tab is located.

FIG. 16 is a diagram illustrating an example of an element and a reference axis that indicates a passage of time.

FIG. 17A is a diagram illustrating an example of a task having an elasticity.

FIG. 17B is a diagram illustrating another example of a task having an elasticity.

FIG. 17C is a diagram illustrating another example of a task having an elasticity.

FIG. 18 is a diagram illustrating an example of a displayed scheduler.

FIG. 19 is a flowchart illustrating an example of a method for generating an element having an elasticity and for inserting the generated element into a reference axis.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Example implementations relate to an interface apparatus and method of managing elastic elements that have an adjustable length. To this end, elements may be expressed and an intuitive tab for management and adjustment of the elements may be defined.

As describe herein, an interface includes hardware and/or software programs designed to communicate information, for example, a display, a screen, a printer, a graphical user interface (GUI), and the like.

As described herein, an element includes objects, for example, shapes, lines, points, and the like, that may be communicated by the interface.

As described herein, an element having elasticity, or an elastic element, may be adjusted by compression, or stretched by expansion. When the compression force is removed, the elastic element may expand back to its original size, and when the expansion force is removed, the elastic element may compress back to its original size.

The element may include a shape, for example, a square, rectangle, triangle, circle, ellipse, a combination thereof, or other desired shape. The element may include a content, for example, a contents list, a text list, a task list used in scheduling, and the like.

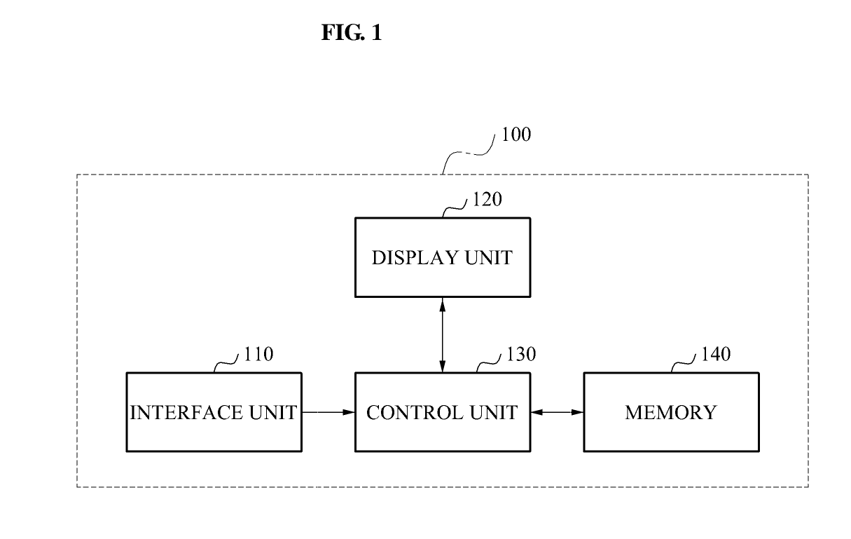

FIG. 1 illustrates an interface apparatus 100. Referring to FIG. 1, the interface apparatus 100 includes an interface unit 110, a display unit 120, a control unit 130, and a memory 140.

The interface unit 110 is a device for providing an interface to a user. The interface unit 110 may sense manipulations with respect to an element. For example, the interface unit 110 may sense generation of the element, movement of the element, removal of the element, fixation and adjustment of the element using an adjustment tab, combination of the element using a combination tab, and division of the element using a division tab. An element may be manipulated by a user, for example, through a computer and with the use of a mouse, a keyboard, a touch pad, and the like.

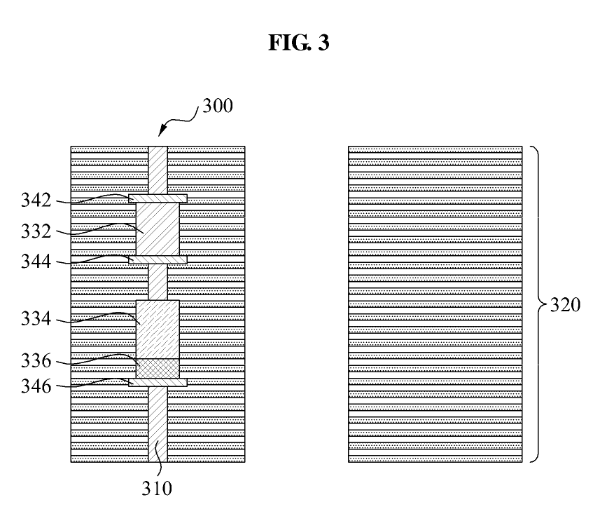

The display unit 120 may display state information (or indicator) generated during operation of the interface apparatus 100. The display unit 120 may display, as illustrated in FIG. 3, an element that has an elasticity, and a reference axis for arranging the element. The display unit 120 may include, for example, a liquid crystal display (LCD) device, a light emitting diode (LED) device, an organic light emitting diode (OLED), a plasma display, and the like.

The memory 140 may store a program for controlling operations of the interface apparatus 100 and information of elements that may be arranged in the reference axis.

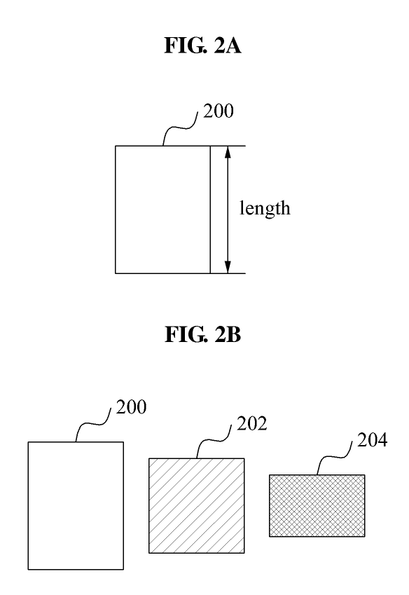

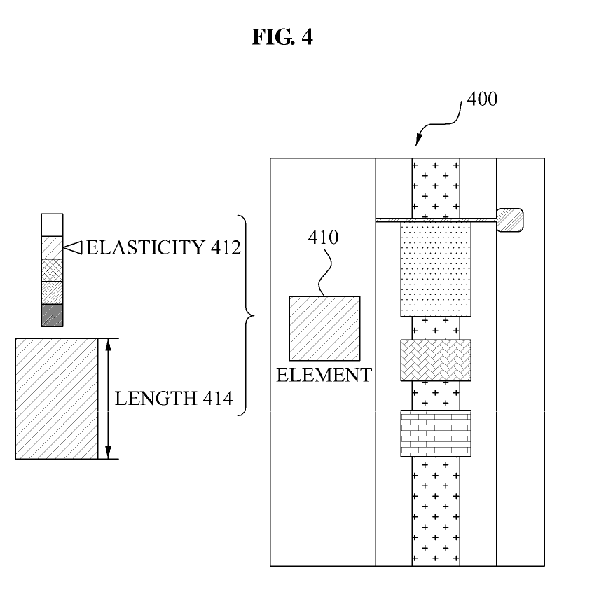

The control unit 130 may receive a request for generation of the element and element information through the interface unit 110. The control unit 130 may generate elements, for example, the elements illustrated in FIGS. 2A and 2B, based on the element information. The generated elements may have information about the length and elasticity of the element as shown in FIG. 4. If element information is not inputted at the time an element is requested, the control unit 130 may generate an element having a predetermined length and a predetermined elasticity. For example, when the element having the adjustable length is used in displaying a contents list, the control unit 130 may designate the length and elasticity of the element to be the same as the length and elasticity of frequently used contents, favorite contents, significant contents, and the like.

The control unit 130 may arrange the elements in the reference axis as illustrated in FIG. 3. When a manipulation of inserting the element into the selection area is sensed by the interface unit 110, and the selection area where the element to be inserted has a sufficient space, the control unit 130 may insert the element into a selection area.

In some embodiments, the control unit 130 may determine that the element will fit into the space of the selection area, if the element, and the elements already arranged in the selection area, are adjusted. Therefore, the control unit 130 may adjust both a length of the elements already arranged in the selection area and a length of the element to be inserted, to thereby insert the element into the selection area. In various embodiments, the control unit 130 may adjust the length of the elements, for example, when the selection point of the selection area where the element is to be inserted has insufficient space, and when the selection area itself has insufficient space even though the elements already arranged have been moved. Both the length of the elements already arranged and the length of the element to be inserted may be adjusted to secure sufficient space where the element is inserted.

In some embodiments, the control unit 130 may determine that there is not enough room in a selection area for the element to be inserted, even if the elements are compressed to their minimum length. For example, an element may have a compression limit, thus limiting the length that the element may be minimized. When an element is attempted to be inserted into a selection area that does not have enough space, the insertion fails.

The control unit 130 may receive, from a user, an input of the selection area through the interface unit 110. The control unit 130 may verify spaces of the reference axis where the element is to be inserted, and determine, as the selection area, a space having a predetermined higher priority for insertion from among the verified spaces, and insert the generated element into the selection area at the space having the predetermined higher priority.

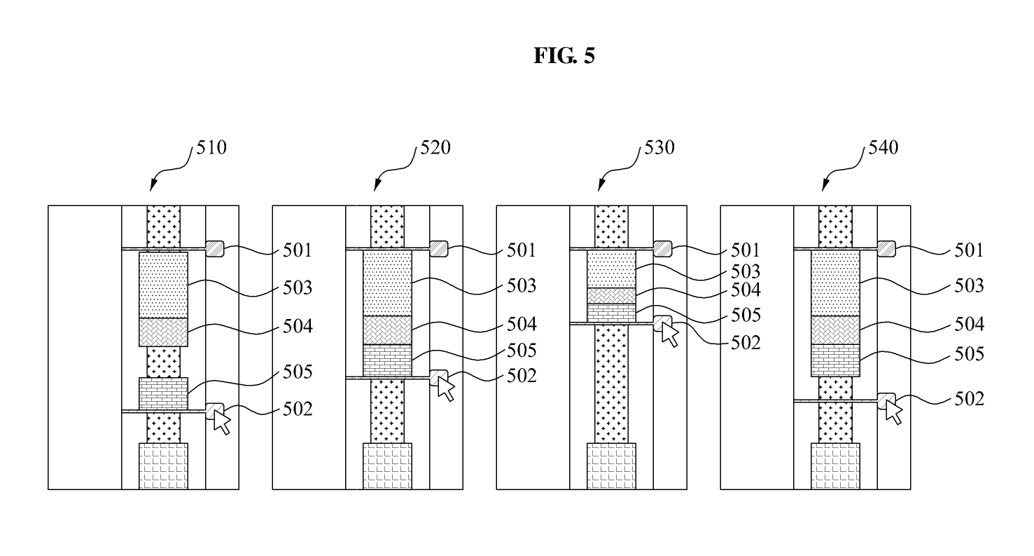

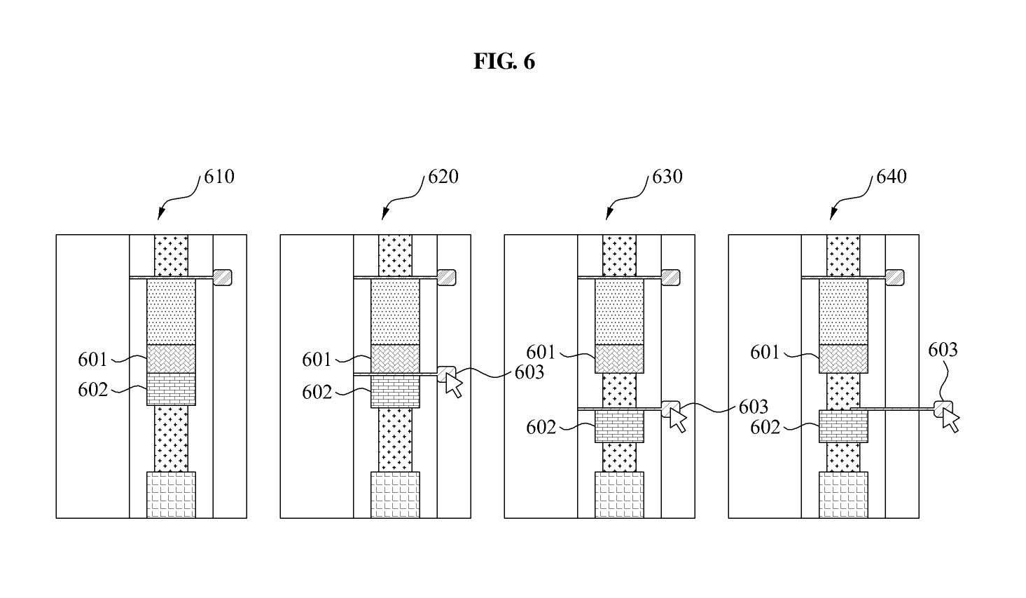

The control unit 130 may sense manipulations with respect to the element performed by an adjustment tab, a division tab, and/or a combination tab, through the interface unit 110. The control unit 130 may compress or move the element in correspondence with an adjustment of the adjustment tab. Manipulations of the element using the adjustment tab will be described with reference to FIGS. 5 to 6.

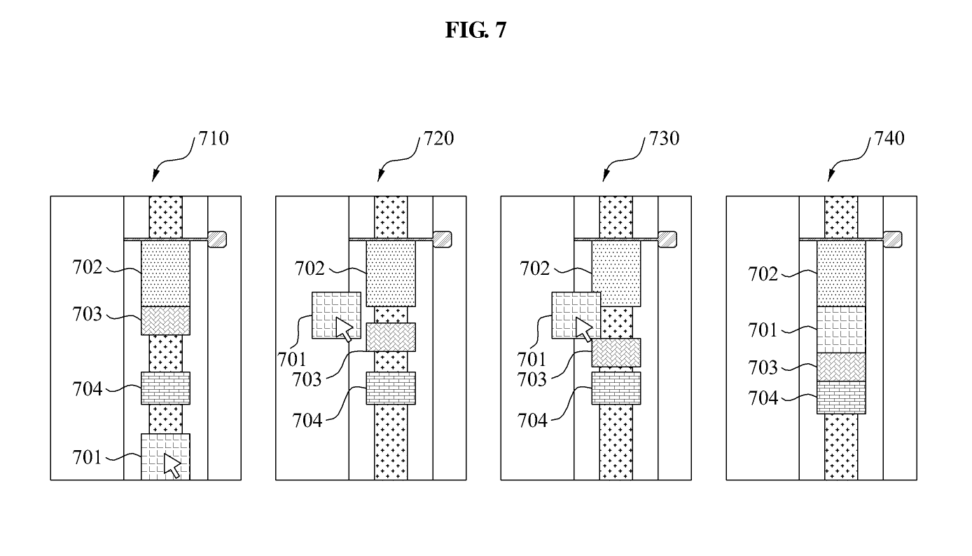

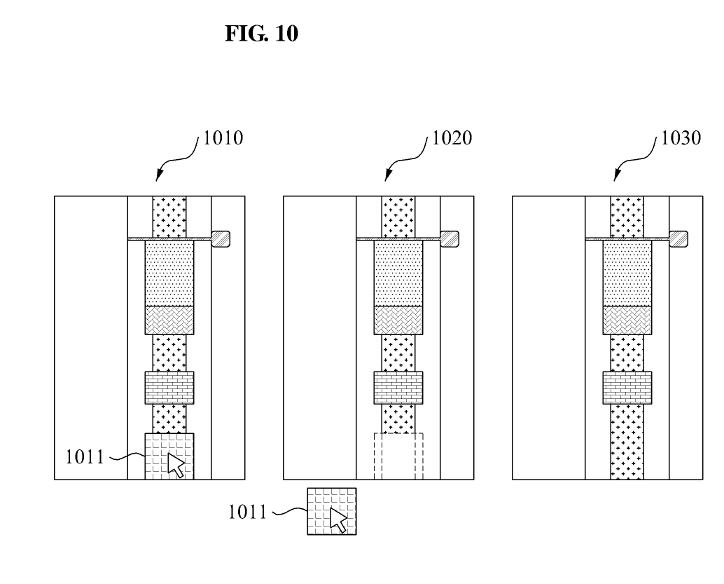

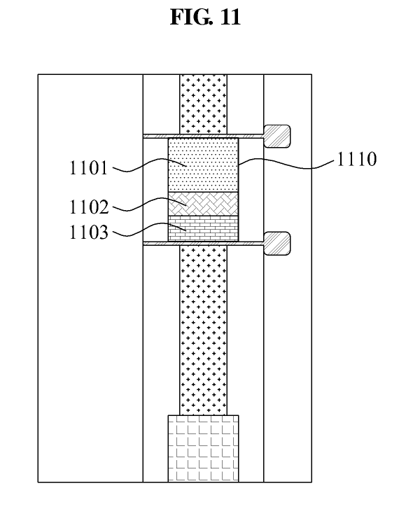

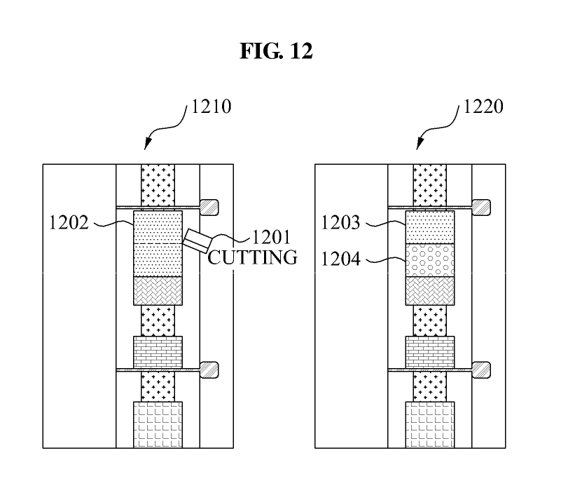

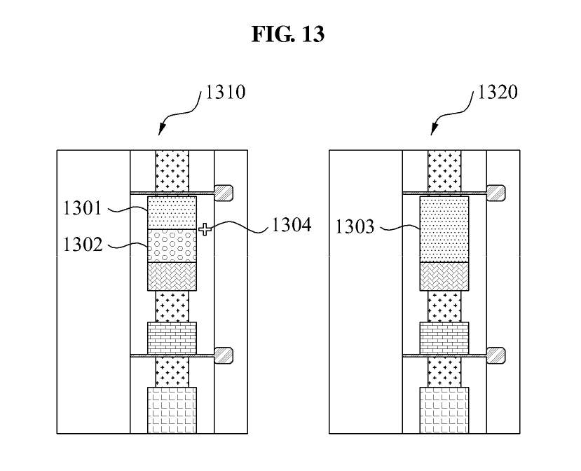

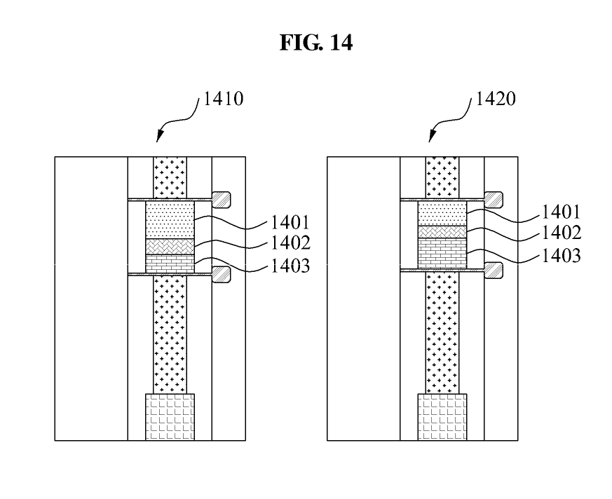

The control unit 130 may move the element when sensing a movement of the adjustment tab performed in the interface unit 110. Examples of moving the element will be described with reference to FIGS. 7-9. The control unit 130 may remove the element when sensing a removal of the element performed in the interface unit 110. An example of removing an element will be described with reference to FIG. 10. The control unit 130 may generate an element group when sensing grouping of the elements performed in the interface unit 110. An example of generating an element will be described with reference to FIG. 11. The control unit 130 may divide the element when sensing a division of the element by the division tab performed in the interface unit 110. An example of dividing an element will be described with reference to FIG. 12. The control unit 130 may combine elements when sensing a combination of the elements by the combination tab performed in the interface unit 110. An example of combining elements will be described with reference to FIG. 13. The control unit 130 may change the elasticity of the element when receiving a request for changing the elasticity of the element. An example of changing the elasticity will be described with reference to FIG. 14.

FIG. 2A illustrates an example of an element 200 having an elasticity. Referring to FIG. 2A, the element 200 may have a length, and a degree of the elasticity and may be displayed using shading or color of the element.

FIG. 2B illustrates an example in which an element having an elasticity is adjusted depending on a change in compression. Referring to FIG. 2A, when the element 200 is compressed, for example, the compression may be expressed by a shading as shown in a first element 202. If the element is compressed even further, the shading may become darker, as illustrated in second element 204 illustrated in FIG. 2B. As shown in the first element 202 and the second element 204, an increase in compression of the element may be expressed by darker shading of the element.

FIG. 3 illustrates an example of a display. Referring to FIG. 3, an output display 300 may include a reference axis 310, elements 332, 334, and 336, and fixation tabs 342, 344, and 346.

For example, the elements 332, 334, and 336 may be elements based on elasticity, and the fixation tabs 342, 344, and 346 may be tabs that may fix the elements 332, 334, and 336 into a confined space to limit a movement or flexibility of the elements. For example, element 332 is disposed between fixation tab 342 and fixation tab 344. Elements 334 and 336 are disposed between fixation tab 344 and fixation tab 346. The fixation tabs may be fixed such that elements are limited to being disposed in the space between two fixation tabs. The fixation tabs may be moved along the reference axis, they may be removed from the reference axis, and/or they may be added to the reference axis. A time tab 320 indicating an interval of time with expression of a plurality of vertical lines may be outputted as a background.

FIG. 4 illustrates an example of generating an element having an elasticity. Referring to FIG. 4, the control unit 130 may receive, from a user, an elasticity 412 and a length 414 of an element, and generate the element 400 based on the elasticity 412 and the length 414. In some embodiments, the control unit 130 may generate an element 400 having a predetermined elasticity 412 and length 414, when failing to receive the element information from the user at the time of generating the element.

FIG. 5 illustrates an example of adjusting elements having an elasticity using an adjustment tab. Referring to FIG. 5, a process of adjusting elements 503, 504, and 505 existing between a first adjustment tab 501 and a second adjustment tab 502 is illustrated. In this example, the adjustment tab may be a tab used when fixing, compressing, and moving elements.

In 510, the interface apparatus may enable the second adjustment tab 502 to be positioned under a third element 505 based on an input of the user. In 520, the interface apparatus may upwardly move the third element 505 together with the second adjustment tab 502 when the second adjustment tab 502 is upwardly moved through a drag operation. The drag operation may be performed by a user, for example, by scrolling a mouse cursor, through a keypad, through a touch screen, and the like.

In 530, the interface apparatus may compress the elements 503, 504, and 505 in proportion to respective elasticity of the elements 503, 504, and 505 because there is no spare space between the first adjustment tab 501 and the second adjustment tab 502. The second adjustment tab 502 may be upwardly moved through a drag operation. As the second adjustment tab 502 is moved upwardly, elements 503, 504, and 505 are compressed based upon their respective elasticities.

When the second adjustment tab 502 is moved downwardly through the drag operation, in 540, the interface apparatus may restore the elements 503, 504, and 505 to their initial lengths and elasticities.

FIG. 6 illustrates another example of adjusting elements having an elasticity using an adjustment tab. Referring to FIG. 6, a process of moving a second element 602 by adjusting an adjustment tab 603 is illustrated.

In 610, the interface apparatus may arrange and display a plurality of elements in a reference axis. In 620, the interface apparatus may receive, from a user, an input of positioning the adjustment tab 603 between a first element 601 and a second element 602. In 630, the interface apparatus may downwardly move the second element 602 positioned under the adjustment tab 603, when sensing that the adjustment tab 603 is downwardly moved through a drag operation, for example, a drag operation performed by a user with a cursor, with a touch pad, and the like. In 640, the interface apparatus may sense that the adjustment tab 603 is removed from a scheduler through a drag operation of a user. As illustrated in the example of 640, for example, each of the elements below adjustment tab 603 may be considered removed from the schedule or not part of the schedule.

FIG. 7 illustrates an example of moving an element. Referring to FIG. 7, a process of moving an element between other elements is illustrated. In 710, the interface apparatus may receive a selection of a first element 701 to be moved. In 720 and 730, the interface apparatus may receive a selection of a position to which the first element 701 is to be moved. In 720 and 730, when the interface apparatus senses that first element 701 is to be moved between second element 702 and third element 703, the interface apparatus may downwardly move a third element 703 and a fourth element 704 to a lower space to create a spare space where the first element 701 may be inserted. In 740, the interface apparatus may move the first element 701 between the second element 702 and the third element 703.

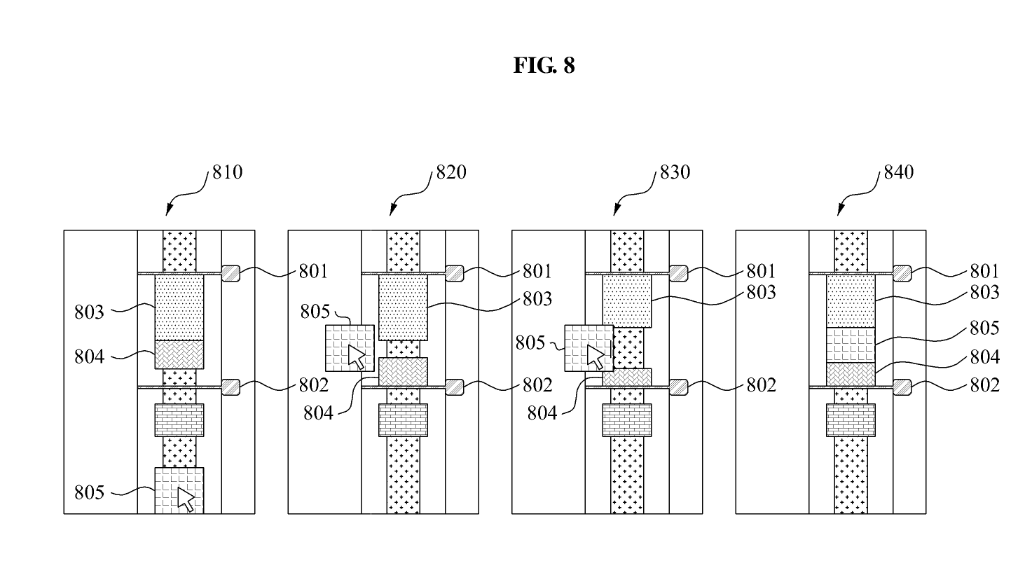

FIG. 8 illustrates another example of moving an element. Referring to FIG. 8, a process of moving an element between elements existing between adjustment tabs is illustrated. In 810, the interface apparatus may receive, from a user, a selection of a third element 805 to be moved. In 820, the interface apparatus may receive a selection of a position to which the third element 805 is to be moved between a first element 803 and a second element 804. In this example, the first element 803 and the second element 804 are previously arranged between a first adjustment tab 801 and a second adjustment tab 802.

In 830, the interface apparatus may secure a space where the third element 805 is to be inserted. The interface apparatus may determine that the available space is not enough for third element 805 to be inserted, however, if elements 803, 804, and 805 were partially or fully compressed, the third element 805 would have enough spare space. The interface apparatus may compress the lengths of the first element 803, the second element 804, and the third element 805 using respective elasticity of the elements 803, 804, and 805 to thereby secure the space where the third element 805 is to be inserted, because the space where the third element 805 is inserted is insufficient due to the distance between the first adjustment tab 801 and the second adjustment tab 802. In 840, the interface apparatus may insert the third element 805 between the first element 803 and the second element 804.

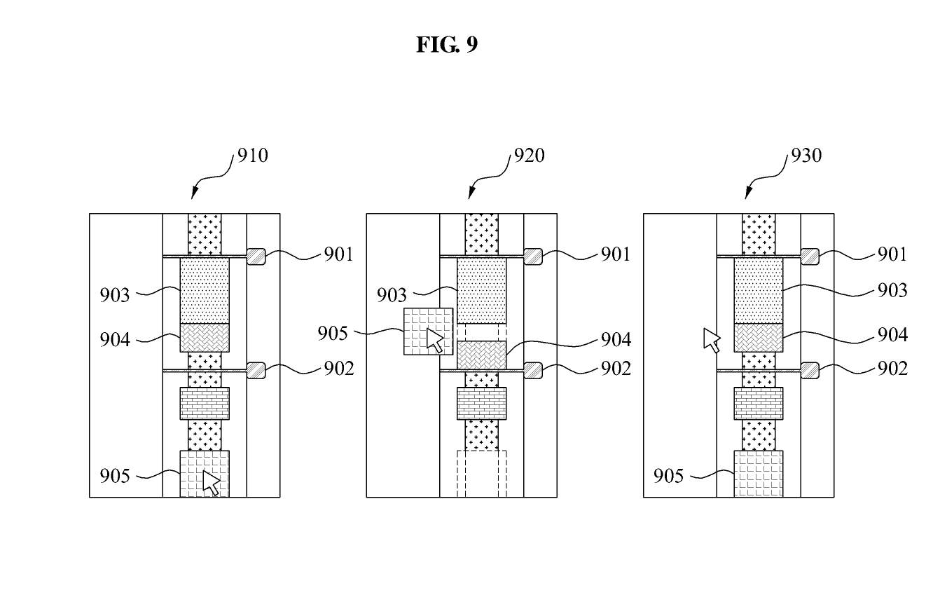

FIG. 9 illustrates an example of a failure in movement of an element. Referring to FIG. 9, a process of moving an element between elements arranged between adjustment tabs is illustrated. In 910, the interface apparatus may receive, from a user, a selection of a third element 905 to be moved. In 920, the interface apparatus may receive, as between a first element 903 and a second element 904, a selection of a position to which the third element 905 is moved. In this example, the interface apparatus may verify whether there is enough spare space for the third element 905 to be moved, based upon the respective length and elasticity of the first element 903, the second element 904, and the third element 905. In this example, the first element 903 and the second element 904 are previously arranged between a first adjustment tab 901 and a second adjustment tab 902.

In some embodiments, the interface apparatus may determine that third element 905 will not fit in the space between adjustment tab 901 and adjustment tab 902. For example, interface apparatus may determine that even if first element 903, second element 904, and third element 905 were each compressed to their minimum size, each of the first element 903, the second element 904, and the third element 905 would not all fit between the space of adjustment tab 901 and adjustment tab 902. Thus, the attempt to insert third element 905 fails. When failing to move the third element 905 to a selected position in 920, the interface apparatus may arrange the third element 905 to an original position in 930.

FIG. 10 illustrates an example of removing an element. Referring to FIG. 10, in 1010, the interface apparatus may receive, from a user, a selection of an element 1011 to be removed. In 1020, the interface apparatus may sense that the element 1011 has been moved to an area outside of a display area through a drag operation of the user. The moved element 1011 may be released by the drag operation to the area outside of the display area. In 1030, the interface apparatus may remove the element 1011 from the display.

FIG. 11 illustrates an example of grouping elements to generate an element group. Referring to FIG. 11, the interface apparatus may group a first element 1101, a second element 1102, and a third element 1103 to generate an element group 1110. The first element 1101, the second element 1102, and the third element 1103 within the element group 1110 may maintain their elasticity when being grouped.

FIG. 12 illustrates an example of dividing an element. Referring to FIG. 12, in 1210, the interface apparatus may sense a division of a first element 1202 by a division tab 1201. In 1220, the interface apparatus may divide the first element 1202 into a second element 1203 and third element 1204. Second element 1203 and third element 1204 have the same elasticity.

FIG. 13 illustrates an example of combining elements. Referring to FIG. 13, in 1310, the interface apparatus may sense a selection of a first element 1301 and second element 1302 to be combined by a combination tab 1304. In 1320, the interface apparatus may combine the selected first element 1301 and second element 1302 into a third element 1303. The interface apparatus may combine the elements 1301 and 1302 into the third element 1303 by weight-averaging the elasticity of the elements 1301 and 1302 in proportion to the length of the elements 1301 and 1302.

FIG. 14 illustrates an example of changing an elasticity of an element. Referring to FIG. 14, in 1410, the interface apparatus may receive, from a user, an input of a change in an elasticity of a third element 1403. For example, the interface apparatus may receive, a user input that increases the elasticity of the third element 1403.

In 1420, the interface apparatus may adjust respective lengths of elements 1401, 1402, and 1403 based on the changed elasticity of the third element 1403 and elasticity of the first and second elements 1401 and 1402. Accordingly, the lengths of the elements 1401, 1402, and 1403 may be adjusted as illustrated in 1420 to accommodate the change in elasticity.

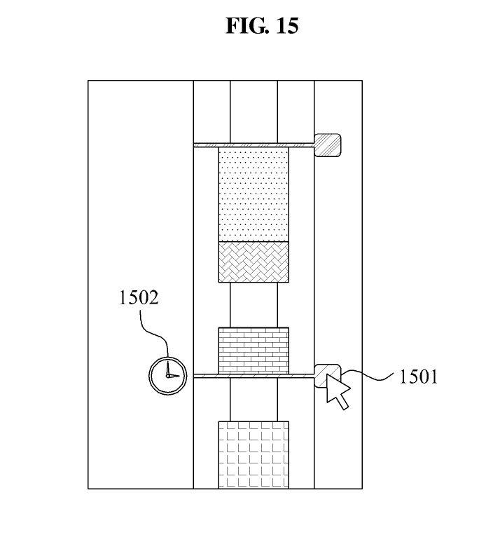

FIG. 15 illustrates an example of outputting additional information, for example, where an adjustment tab is located. Referring to FIG. 15, the interface apparatus may output additional information about a reference axis where an adjustment tab 1501 is located, for example, when sensing that a mouse pointer is located on the adjustment tab 1501. In FIG. 15, a clock may be output to indicate a time, in an example where the reference axis indicates a passage of time.

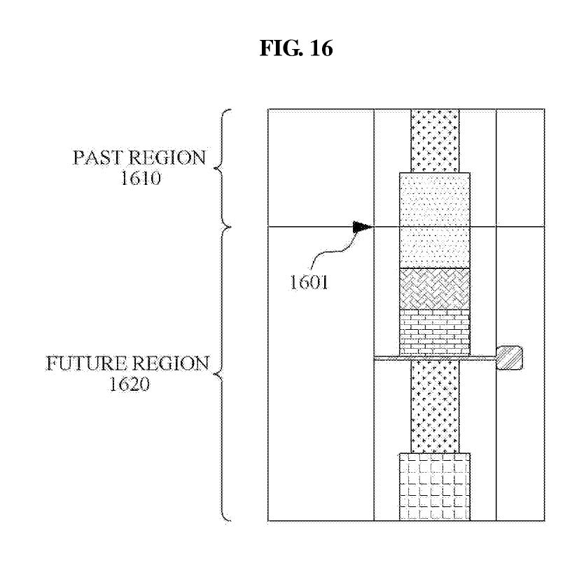

FIG. 16 illustrates an example of an element in a case where a reference axis indicates a passage of time. Referring to FIG. 16, the interface apparatus may display a current time using a current time designation tab 1601 when the reference axis indicates the passage of time. The interface apparatus may display a past region 1610 and a future region 1620, in the same manner or in a different manner. For example, the interface apparatus may output the past region 1610 using a watermark.

The interface apparatus may display an element based on an elasticity in a different type when the element is applicable in a scheduler.

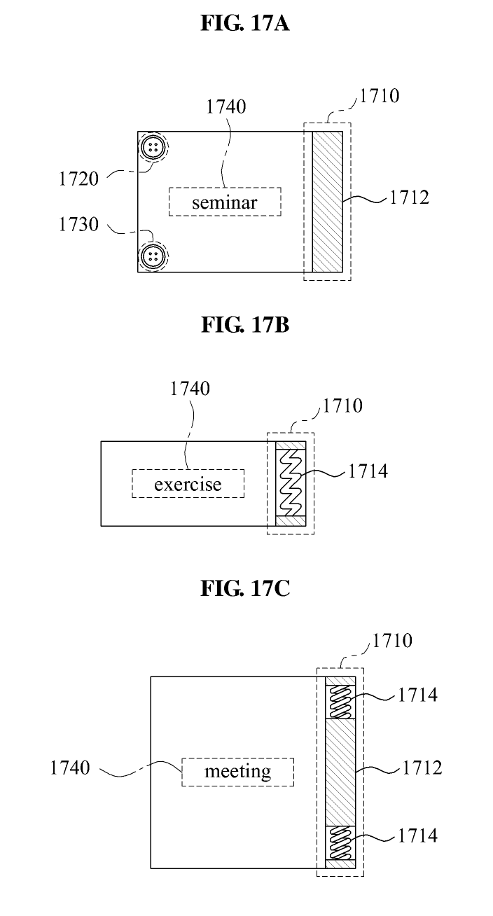

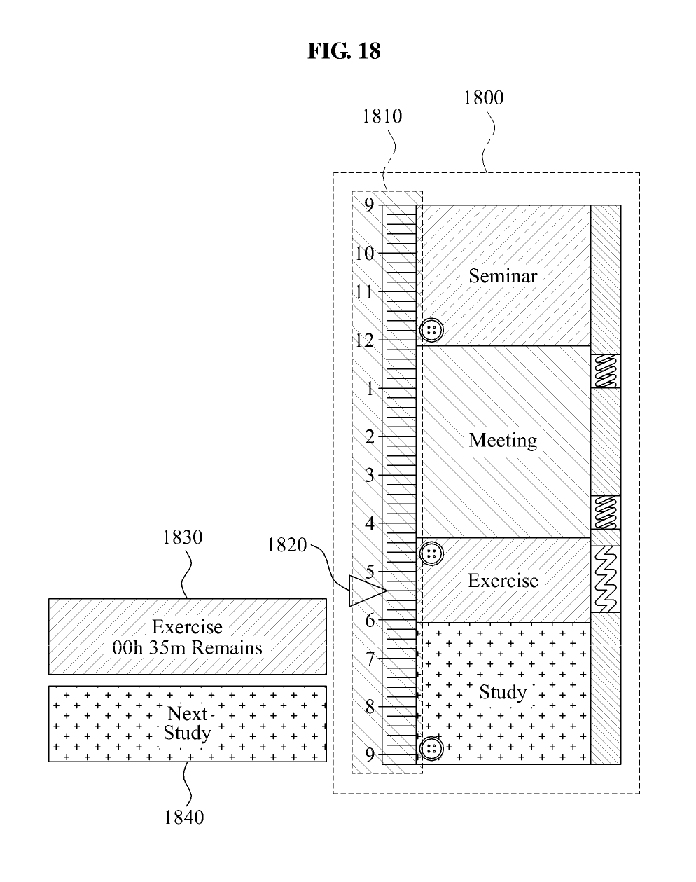

An element existing in the scheduler may be referred to as a task. Hereinafter, a task based on the elasticity will be described with reference to FIGS. 17A, 17B, 17C and 18.

FIG. 17A illustrates an example of a task having an elasticity. FIG. 17B illustrates another example of a task having an elasticity. FIG. 17C illustrates another example of a task having an elasticity. The task based on the elasticity may include a task name 1740 and an elasticity expression area 1710. The task may further include a start time fixation tab 1720 indicating a fixed start time of the task and an end time fixation tab 1730 indicating a fixed end time of the task. The start time fixation tab 1720 and the end time fixation tab 1730 may be expressed, for example, with a shape such as a button, a tack, a clothes-pin, and the like.

The elasticity expression area 1710 may be displayed using a duration time tab 1712 indicating a minimal duration time required for the task and using a flexible time tab 1714 used for flexibly displaying a spare time used for the task.

For example, the duration time tab 1712 may be displayed in the form of a shape such as a rectangle. The flexible time tab 1714 may be displayed in the form of a shape such as a spring. In this example, the flexible time tab 1714 may visually display an elasticity using the spring.

The task of FIG. 17A may be, for example, a task without a flexible time in which a start time and an end time are fixed. The task of FIG. 17B may be, for example, a task displayed with only the flexible time in which the start time and the end time are not fixed, and the flexible time may be reduced or removed by other tasks.

The task of FIG. 17C may be, for example, a task displayed with the flexible time and the duration time in which the start time and the end time are not fixed, and the flexible time may be reduced by other tasks.

FIG. 18 illustrates an example of a displayed scheduler. A scheduler 1800 may include a time axis tab 1810, a plurality of tasks, and a current time designation tab 1820. Here, the time axis tab 1810 may be displayed in shape of a tape measure, and the current time designation tab 1820 may be displayed in a shape of an arrow.

As for the scheduler 1800, a current task displaying area 1830 indicating a current task together with a remaining time and a subsequent task displaying area 1840 indicating tasks to be performed subsequently.

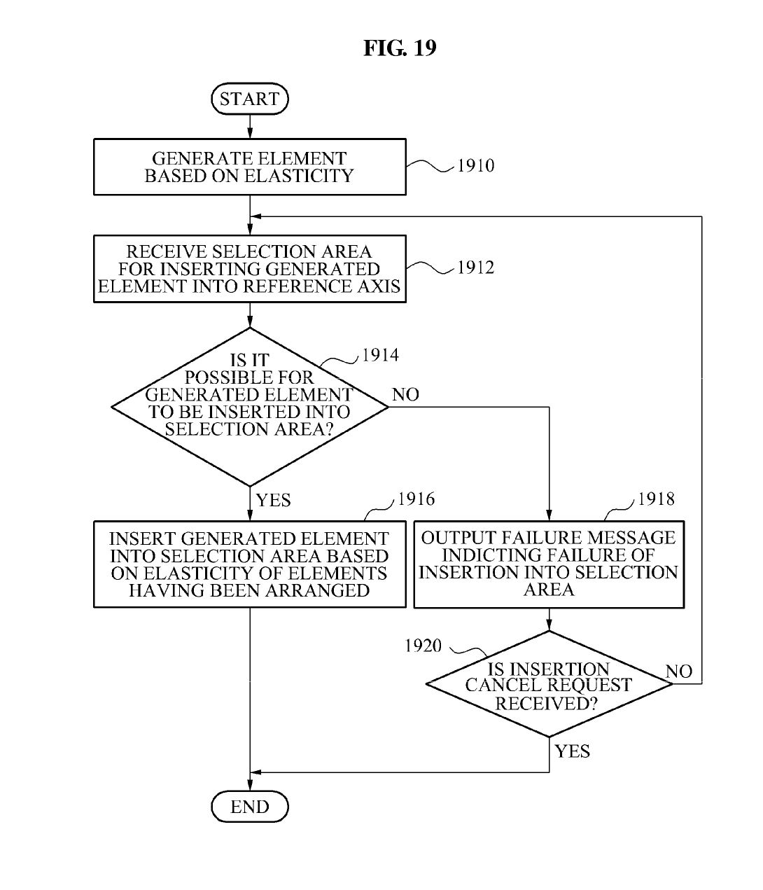

A method of generating and inserting an element, from among methods of managing the elements having the elasticity as described above, will be described with reference to FIG. 19.

FIG. 19 is a flowchart illustrating an example of a method for generating an element having an elasticity and for inserting the generated element into a reference axis. Referring to FIG. 19, the interface apparatus according to example embodiments may generate an element having an elasticity in 1910. For example, the element may include information about a length and elasticity of the element. The element may further include a name of the element, a fixed start time, a fixed end time, a duration time, a flexible time, and the like. The element may be generated in response to a user input requesting an element to be generated. The user input may include at least one of length information, elasticity information, start time information, duration information, flexible time information, and the like.

In 1912, the interface apparatus may receive a selection area of a reference axis where the generated element is to be inserted.

In 1914, the interface apparatus may verify whether the generated element may be inserted into the selection area. In 1914, the interface apparatus may determine that the selection area does not have enough spare space for the generated element to be inserted. In some embodiments, in 1914 the interface apparatus may determine that the selection area does have enough spare space for the generated element to be inserted, but the elements already arranged therein, and the generated element must be compressed partially, or completely.

In 1916, when the interface apparatus determines that the generated element may be inserted into the selection area, the interface apparatus may insert the generated element into the selection area based on an elasticity of elements located around the selection area, according to the verified result. However, when the generated element cannot be inserted into the selection area according to the verified result in 1914, the interface apparatus may proceed to 1918, and output a failure message indicating a failure in insertion of the element into the selection area. For example, the failure message may be generated as at least one of a string, a sound, a voice, an image, a combination thereof, and the like.

In 1920, the interface apparatus may verify whether to receive an insertion cancel request of the generated element. When receiving the insertion cancel request according to the verified result, the interface apparatus may terminate a corresponding algorithm. When not receiving the insertion cancel request according to the verified result, the interface apparatus may return to 1912 and repeatedly perform the method.

According to example embodiments, provided is an interface apparatus including a display unit to display an element that is adjustable and has an elasticity, and a reference axis for arranging the element, an interface unit to sense a manipulation with respect to the element, and a control unit to change a display state of the element based on the sensed manipulation. When registering a new element by arranging elements based on an elasticity of the elements, a length of the elements may be automatically changed based on the elasticity even without separately adjusting the elements already arranged in the reference axis, whereby a change and adjustment may be convenient.

The processes, functions, methods and software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An interface apparatus, comprising:
a display unit to display an element having an elasticity and a length which are adjustable, and a reference axis for arranging the element;
an interface unit to sense a manipulation with respect to the element; and
a control unit to change a display state of the element based on the sensed manipulation.

2. The interface apparatus of claim 1, wherein the element is generated based on elasticity information indicating elasticity, initial length information, and the amount the length may be adjusted.

3. The interface apparatus of claim 1, wherein the manipulation with respect to the element is performed by an adjustment tab for fixing and adjusting the element, and the interface unit senses a movement of the adjustment tab.

4. The interface apparatus of claim 3, wherein the element is compressed or moved in correspondence with the manipulation of the adjustment tab.

5. The interface apparatus of claim 1, wherein the manipulation with respect to the element includes inserting the element into a selection area of the reference axis, and the control unit inserts the element into the selection area without changing the length of the element, when the selection area has a sufficient space where the element is inserted.

6. The interface apparatus of claim 1, wherein the manipulation with respect to the element includes inserting the element into a selection area of the reference axis having elements already arranged therein, and before the element is inserted the control unit performs at least one of moving the elements already arranged therein, compressing the elements already arranged therein, and compressing the element to create sufficient space for the element to be inserted.

7. The interface apparatus of claim 1, wherein the manipulation with respect to the element includes attempting to insert the element into a selection area of the reference axis having elements already arranged therein, and the control unit moves and adjusts a length of elements already arranged in the reference axis and a length of the element to be inserted to thereby insert the element into the selection area, and determines that the selection area does not have sufficient space for the element even though the elements already arranged in the reference axis are moved and the element and the elements already arranged are compressed.

8. The interface apparatus of claim 1, wherein the interface unit senses a movement of the element outside of a display area, and the control unit removes the element from the display area.

9. The interface apparatus of claim 1, wherein the manipulation with respect to the element is performed by a division tab for dividing the element, the interface unit senses a manipulation of the division tab, and the control unit divides the element into two elements each having the same elasticity.

10. The interface apparatus of claim 1, wherein the interface unit senses a manipulation of a combination tab for combining elements already arranged in the reference axis, and the control unit combines the elements having been arranged in the reference axis into a single element to correspond to the combination tab.

11. The interface apparatus of claim 1, wherein the manipulation with respect to the element includes grouping elements already arranged in the reference axis, the interface unit senses a selection of elements to be grouped, and the control unit groups the selected adjacent elements into a single element maintaining an elasticity of each of the selected elements.

12. The interface apparatus of claim 1, wherein the element is a task being applicable in a scheduler, and the reference axis is a time axis being applicable in the scheduler.

13. The interface apparatus of claim 12, wherein the task includes task information, and the task information includes at least one of a task name, a fixed start time, a fixed end time, a duration time, and a flexible time.

14. The interface apparatus of claim 13, wherein the duration time is displayed in a shape of a rectangle, and the flexible time is displayed in a shape of a spring.

15. The interface apparatus of claim 12, wherein the scheduler is divided into a past region and a future region based on a current time, and the divided scheduler is displayed.

16. The interface apparatus of claim 15, wherein the past region and the future region are divided by shading or watermarks.

17. The interface apparatus of claim 12, wherein the scheduler displays a current time designation tab indicating a current time in the time axis.

18. An interface method, comprising:
displaying an element having an elasticity and a length which is adjustable and a reference axis for arranging the element;
sensing a manipulation with respect to the element; and
changing a display state of the element based on the sensed manipulation.

19. The interface method of claim 18, wherein the element is compressed or moved by an adjustment tab for fixing or adjusting the element.

20. The interface method of claim 18, wherein the changing inserts the element into a selection area of the reference axis without changing the length of the element when the selection area has a sufficient space where the element is to be inserted.

21. The interface method of claim 18, wherein the changing changes the length of the element to insert the element into a selection area of the reference axis.

22. The interface method of claim 18, wherein the changing changes a length of elements already arranged in the reference axis based on an elasticity of the elements already arranged to thereby insert the element into a selection area of the reference axis.

23. The interface method of claim 18, wherein the changing removes or divides the element based on the sensed manipulation.

24. The interface method of claim 18, wherein the changing groups or combines elements having been arranged in the reference axis based on the sensed manipulation, and a length of the elements having been arranged is changeable based on an elasticity.
